(19) United States
(12) Patent Application Publication
(10) Pub. No.: US 2018/0123900 A1
(43) Pub. Date: May 3, 2018

(54) SCENARIO DRIVEN, TECHNOLOGY AGNOSTIC NETWORK SIMULATION

(71) Applicant: CA, Inc., New York, NY (US)

(72) Inventors: Charles Abraham Dorr, Rollinsford, NH (US); Adam George Keller, Barrington, NH (US)

(21) Appl. No.: 15/337,546

(22) Filed: Oct. 28, 2016

(51) Int. Cl. H04L 12/24; H04L 12/58

(52) U.S. Cl. CPC H04L 41/145; H04L 51/36

(57) ABSTRACT

A scenario is parsed to determine a set of declarations that define creation of a simulated network having a plurality of network elements, wherein the set of declarations define a type and a quantity for each of the plurality of network elements and defines at least one technology type for a plurality of mock inventory messages to be output from a network simulation of the simulated network. Normalized versions of the plurality of network elements are created based on the type and the quantity defined by the set of declarations. The network simulation of the simulated network is executed and includes outputting the plurality of mock inventory messages that include attributes and status of the plurality of network element from a perspective of the at least one technology type.

### BACKGROUND

The disclosure generally relates to the field of data processing, and more particularly to modeling, design, simulation, or emulation.

Building of networks can be both expensive and complex. This can include configuring and connecting the various network elements within the network. Building of these networks becomes increasing difficult as the scale and complexity of the network increases. Therefore, for development of network management and monitoring tools, network simulators can be created in place of the actual network for development, testing, etc. of the network management and monitoring functionality. However, a network simulator that accurately depicts a network is needed to properly develop and test the network management and monitoring. Even if a network simulator is created, often times the desired scale and complexity may be insufficient to accurately simulate the actual network.

### BRIEF DESCRIPTION OF THE DRAWINGS

Embodiments of the disclosure may be better understood by referencing the accompanying drawings.

FIG. 1 depicts an example system architecture for a technology agnostic network simulation, according to some embodiments.

FIGS. 2-3 depict an example scenario that is input into a network simulation, according to some embodiments.

FIGS. 4-5 depicts a more detailed diagram of example operations and communication by components of an example system architecture in response to creating a network element for a technology agnostic network simulation, according to some embodiments.

FIG. 6 depicts an example service function chain created for inputting into a network simulation, according to some embodiments.

FIG. 7 depicts an example non-normalized message, according to some embodiments.

FIGS. 8-9 depict an example pre-processed message, according to some embodiments.

FIG. 10 depicts an example partially normalized message, according to some embodiments.

FIGS. 11-13 depict flowcharts for a technology agnostic network simulation, according to some embodiments.

FIG. 14 depicts an example application of the network simulation to verify VNA operations, according to some embodiments.

FIG. 15 depicts an example computer device, according to some embodiments.

### DESCRIPTION

The description that follows includes example systems, methods, techniques, and program flows that embody aspects of the disclosure. However, it is understood that this disclosure may be practiced without these specific details. For instance, this disclosure refers to particular types of network elements and technology types for these network elements. But aspects of this disclosure can be also applied to various other types of network elements and technology types for these network elements. In other instances, well-known instruction instances, protocols, structures and techniques have not been shown in detail in order not to obfuscate the description.

### Terminology

This description uses the term “simulation” or “simulator” to refer to any type of software, hardware, firmware, or a combination thereof that models the behavior of a network by determining interaction between various network elements and entities. A network simulator can predict network behavior by modeling the various network elements and entities and interaction and communication between these elements and entities. A simulation can provide mock output messages that provides attributes, status, performance, etc. of various network elements in the simulated network, connectivity among the various network elements, etc.

This description uses the term “network element” to refer to any logical or physical component or device that is part of a network for communication of data, packets, etc. therein. Examples of network elements include a hypervisor, a virtual machine, a virtual router, a logical interface, a switch, a router, a server, a hub, an access point, a controller, a virtual network function, etc. A network element can also refer to any combination of logical or physical network elements that is part of a network for communication data, packets, etc. therein. In other words, a network element can be composed of two or more other network elements. For example, a network element can be a service function chain that can be comprised of a virtual network function(s), a hypervisor(s), a virtual machine(s), an interface(s), a network(s), and a subnet(s) within the network(s).

This description uses the term “normalize” or “normalization” in the context of network simulation to refer to any redefining of different network elements that are of different technology types to a common or generic network element representative, wherein the common or generic network element can be representative of each of the different network elements that have been redefined. For example, a first version of a virtual machine from technology type A can be limited to attributes that include an identifier (e.g., Universal Unique Identifier (UUID), a name, and an associated Media Access Control (MAC) address, while a second version of a virtual machine from technology type B can have a larger set of attributes defining the virtual machine. Both versions of the virtual machine can be normalized to create a common virtual machine that is representative of both versions. In other words, the normalized virtual machine is not technology specific. Rather, the normalized virtual machine can be defined as technology agnostic.

This description uses the term “technology” or “technology type” in reference to network elements. The technology type of a network element can be defined by its attributes. As described above, a same network element for different technologies can have different sets of attributes. For example, a hypervisor of technology X can be defined by four attributes, while a hypervisor of technology Y can be defined by eight attributes. Example technologies type for a network element include OpenStack and OpenDaylight (ODL).

### Overview

Embodiments include simulation of a network having network elements that can be from different technology types. This is in contrast to technology-specific network simulation. For instance, conventional network simulators provide simulation for OpenStack technology, ODL technology, etc. In some embodiments, the network elements are normalized prior to the network simulation. However, output from the network simulation can be normalized, partially normalized, or non-normalized (technology-specific).

Some embodiments can create the specificities of a network element based on a request to include such a network element in the simulation. For example, a network element composed of multiple network elements can be added to the network simulation (either during initial configuration or while the simulation is occurring). For instance, a service function chain can be added to the network simulation, wherein the service function chain can be comprised of a number of virtual functions that include a number of virtual machines. The service function chain can also be comprised of a number of networks having subnets, wherein one or more interfaces are used for connecting a virtual machine to one or more of the subnets. In some embodiments, the network simulator can determine the type and number of network elements needed to create the service function chain and the connectivity among those network elements and the other network elements or entities in the network simulation. Accordingly, a test engineer or developer is not required to provide the specifics of a particular network element being added to the network. Rather, these individuals can generally request the inclusion of a network element without providing all of the specifics needed for addition of the network element to the simulation. Also, the number of particular network elements in some network elements (e.g., the service function chain) can vary. For example, a first service function chain can include five virtual machines, while a second service function chain can include two virtual machines. In some embodiments, the number of particular network elements and their connectivity with other network elements can be randomly determined.

Some embodiments include scenarios that are input into a network simulator. The scenarios can describe the initial configuration of the network (including the number and type of network elements). The scenarios can also describe how the network and its elements are to behave over time as the network simulation is executing. The scenarios provide an abstraction for defining a particular behavior or set of behaviors for a network simulation. For example, the scenarios can dictate how the simulated network will change over time in terms of particular types of network elements (e.g., hypervisors, virtual machines, etc.) being added or removed from the network or modified. These scenarios can be used to test specific code paths of a network management application. In another example, the scenarios can define changes in operational status of various network elements. For example, a hypervisor can be changed from operational to non-operational at time X of the network simulation. After being defined, a scenario can be applied to a network simulator. In response, the network simulator applies the behaviors defined in the scenario to initialize the network simulation and provide modifications to the network and the network elements as the network simulation is executing. For example, various network elements (e.g., routers, switches, virtual machines, hypervisors, etc.) can be added, removed or modified during the network simulation.

The scenarios can also define the different technology types of the network elements to be simulated. Additionally, the scenarios can define how often polled messages are output and the type of polled message to be output from the simulation. For example, scenario A can define that the technology types of the network elements to be simulated include Open Stack and Open Switch, that polled messages are output every 100 seconds, and that the messages include non-normalized and partially normalized polled messages. In another example, scenario B can define that the technology type of the network elements to be simulated include Open Daylight, that the polled messages are output every 200 seconds, and that the polled messages include only partially normalized messages. The incorporation of different scenarios allows testing of network management tools. For example, a scenario can be input to provide a particular network configuration wherein four virtual machines become non-operational at time point A, two hypervisors are added at time point B and another hypervisor's configuration is modified at time point C of the simulation. One or more network management tools can be configured to receive polled messages output from the simulation to determine if these tools properly respond to the simulation.

### Example System Architecture

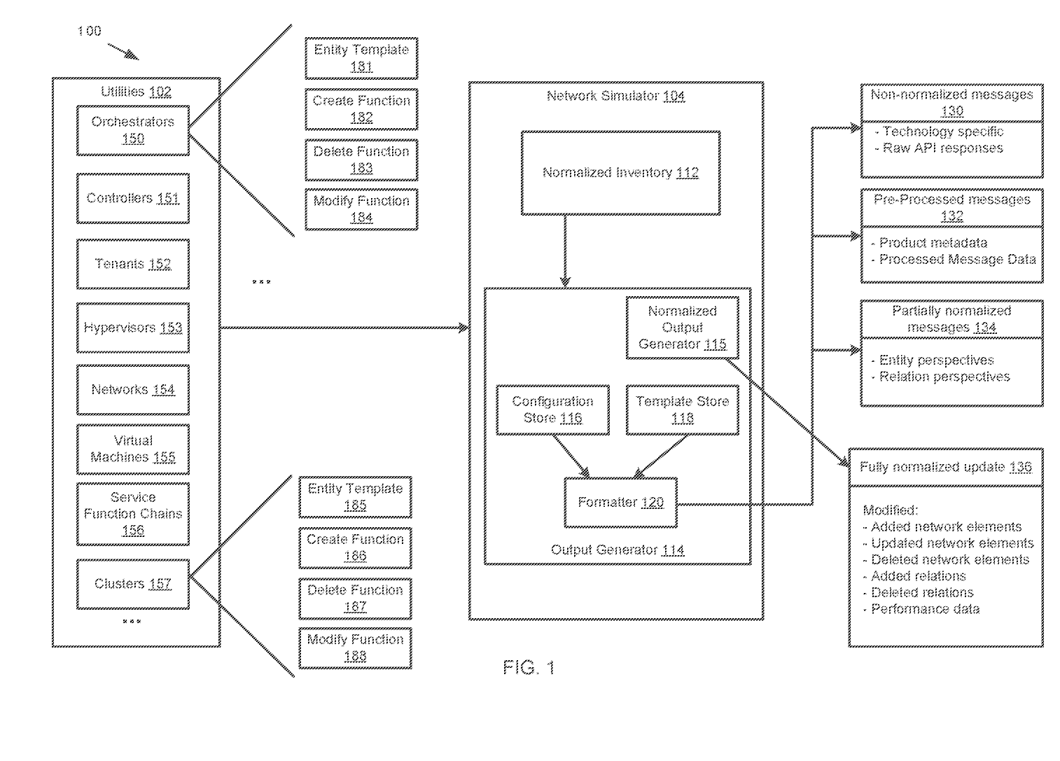

FIG. 1 depicts an example system architecture for a technology agnostic network simulation, according to some embodiments. FIG. 1 depicts a system 100, which includes a network simulator 104. The system 100 also includes utilities 102 having a number of different classes associated with different types of network elements. In this example, the utilities 102 include orchestrators 150, controllers 151, tenants 152, hypervisors 153, networks 154, virtual machines 155, service function chains 156, and clusters 157. Each utility in the utilities 102 can include an entity template, a create function, a delete function, and a modify function. FIG. 1 depicts these components for the orchestrators 150 and the clusters 157. The orchestrators 150 includes an entity template 181, a create function 182, a delete function 183, and a modify function 184. Similarly, the clusters 157 includes an entity template 185, a create function 186, a delete function 187, and a modify function 188. The other utilities in the utilities 102 can also be composed of an entity template, a create function, a delete function, and a modify function.

An entity template for a given network element can define what normalized attributes, status, etc. are to be associated with the network element. Each network element can have a unique entity template. For example, the entity template for a virtual machine can include its unique ID, its associated hypervisor, its interfaces, and its operational status. In contrast, the entity template for a hypervisor can include its unique ID, its associated virtual machines, and its associated virtual network function, and its operational status. As further described below, an instantiation of the entity template for a particular network element is created and stored in the normalized inventory 112 as part of adding the particular network element to the simulated network.

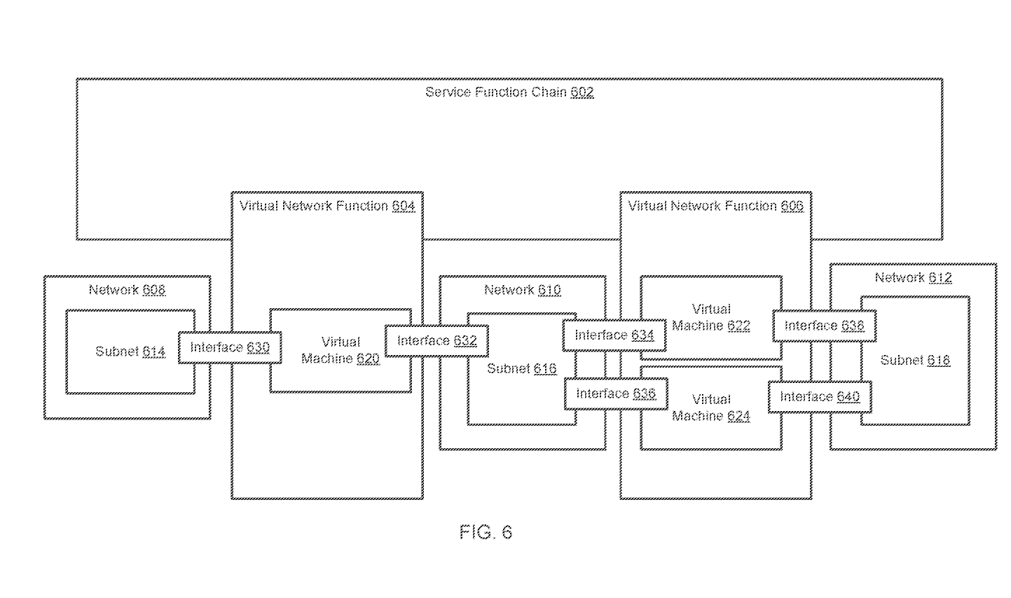

Each create function can include operations to be executed each time an instance of the associated network element is added to the simulated network. These operations can include instantiating other network elements that are within the network element being added. An example of such a network element is a service function chain, which is depicted in FIG. 6 (further described below). The operations for the create function can also include connecting the new network element to other types of network elements in the simulated network. For example, a new created virtual machine is connected with a hypervisor and one or more interfaces in the simulated network.

Similarly, each delete function can include operations to be executed each time an instance of the associated network element is removed from the simulated network. Similar to the create function example above, if the network element being deleted is composed of other network elements, operations of the delete function can include deleting those other network elements. An example of such a network element is a service function chain, which is depicted in FIG. 6 (further described below). The operations for the delete function can also include removing connectivity between the network element being deleted and other network elements in the simulated network. For example, if the network element being deleted is a virtual machine, the instantiation of its associated hypervisor is updated to remove relationship or association with this virtual machine.

Similarly, each modify function can include operations to be executed each time an existing instance of the associated network element is modified. For example, if the operational status of a network interface is toggled from up to down, the corresponding link between the network interface and its counterpart on the other end of the link may be removed.

The network simulator 104 can receive instructions or declarations for the initial creation of a simulated network. For example, the instructions can include type, quantity, technology type, etc. of each network element to be included. Instances of a creation class for each network element to be created as part of the simulated network can be created from the utilities 102 and serve as input into the network simulator 104. In some embodiments, these instructions or declarations can be in the form of scenarios (which are further described below).

The network simulator 104 includes a normalized inventory 112 and an output generator 114. The output generator 114 includes a configuration store 116, a template store 118, a formatter 120, and a normalized output generator 115. The normalized inventory 112 includes storage of data defining network elements already in the simulated network. For example, data defining a network element can include its connectivity with other network elements in the simulated network, its attributes, etc.

The configuration store 116 and the template store 118 store configurations and templates, respectively, for messages to be output during or after the network simulation. For example, a configuration for outputting a message providing status of network elements of a particular type can have a corresponding template for formatting the message. In some embodiments, each pair of configuration and template are specific to a given technology type for a given type of network element. Therefore, if there are five possible technology types for a given type of network element, a configuration and template are stored for each of the five technology types of a given type of network element for a given message. The template defines what data is to be included in building the message, and the configuration defines how to populate the data in the message. For example, a message having a given configuration and template can be output from the simulation. The message can include status of a given type of network element (e.g., virtual machine) for all network elements of that type. A template can identify what attributes, status, etc. are to be included in a message. The associated configuration can provide how to populate the data in the template (e.g., the format, order, etc.).

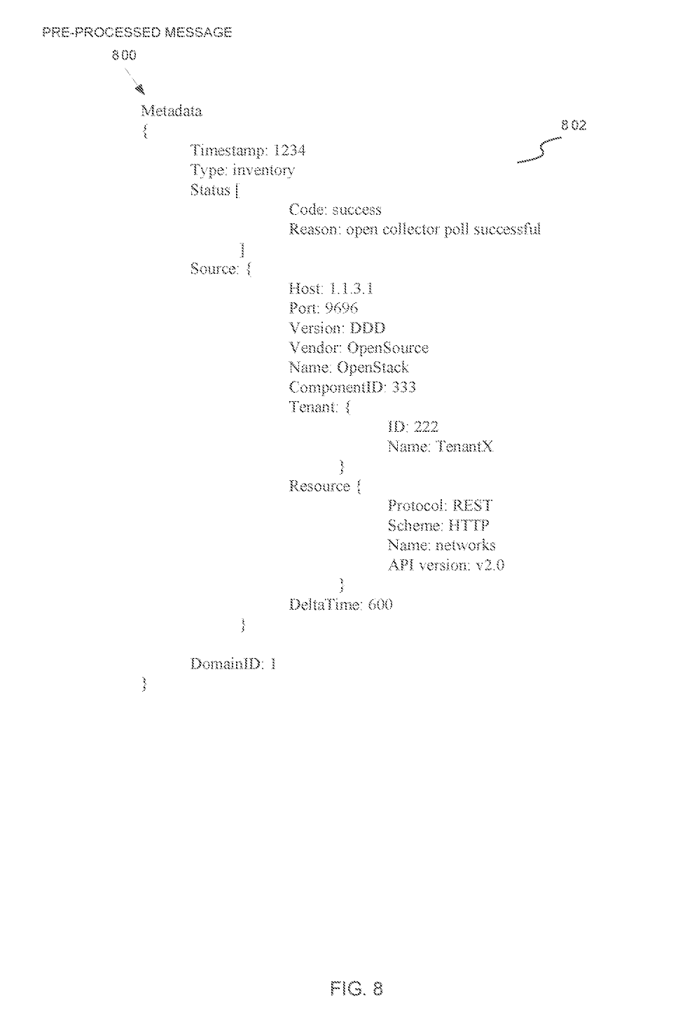

The configuration and template for a message for a given type of network element of a given technology type can be derived from an actual message generated by an actual network having network elements of that given technology type. These messages can be created and output in response to network management tools or systems querying the network for status, performance data, etc. of various network elements in the network. In some embodiments, these messages can be output periodically. For example, a scenario can define the type of periodic timing of messages (as further described below). Also, the types of messages can include a non-normalized (technology specific) messages, a partially normalized message from a perspective of a single technology type, and a pre-processed message. Examples of these different types of messages are depicted in FIGS. 8-11 (which are further described below).

In response to polling, request for status, performance, etc. (e.g., a polling request received on a periodic basis), the formatter 120 creates and outputs a message. The formatter 120 determines the type of message and a time when the message is to be output. For example, the formatter 120 can receive this information from a scenario that is input into the network simulator 104 that includes declarations defining the type of messages and timing of output of such messages. For instance, a scenario can include a declaration to instruct the formatter 120 to output a non-normalized message for all the virtual machines in the simulated network to indicate a status every 50 seconds.

To create the message, the formatter 120 retrieves the configuration for the particular message from the configuration store 116. The configuration store 116 can include a reference or pointer to the template associated with the configuration for this message. Accordingly, the formatter 120 can retrieve the associated template from the template store 118 using the reference or pointer. The formatter 120 can also retrieve values for the different fields of the template from the normalized inventory 112.

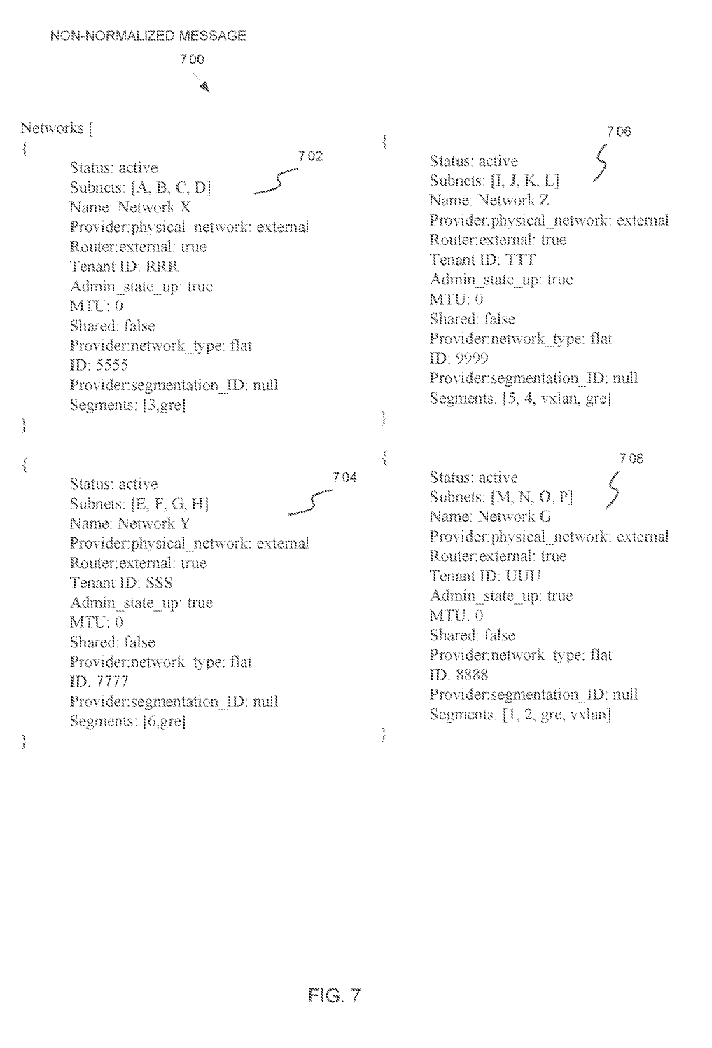

If the message is a non-normalized message that is technology specific, the formatter 120 can then output the message after setting the values for the different attribute fields in the template for the message. Such a message can be part of non-normalized messages 130 being output from the formatter 120. An example of the non-normalized messages 132 is depicted in FIG. 7 (which is further described below).

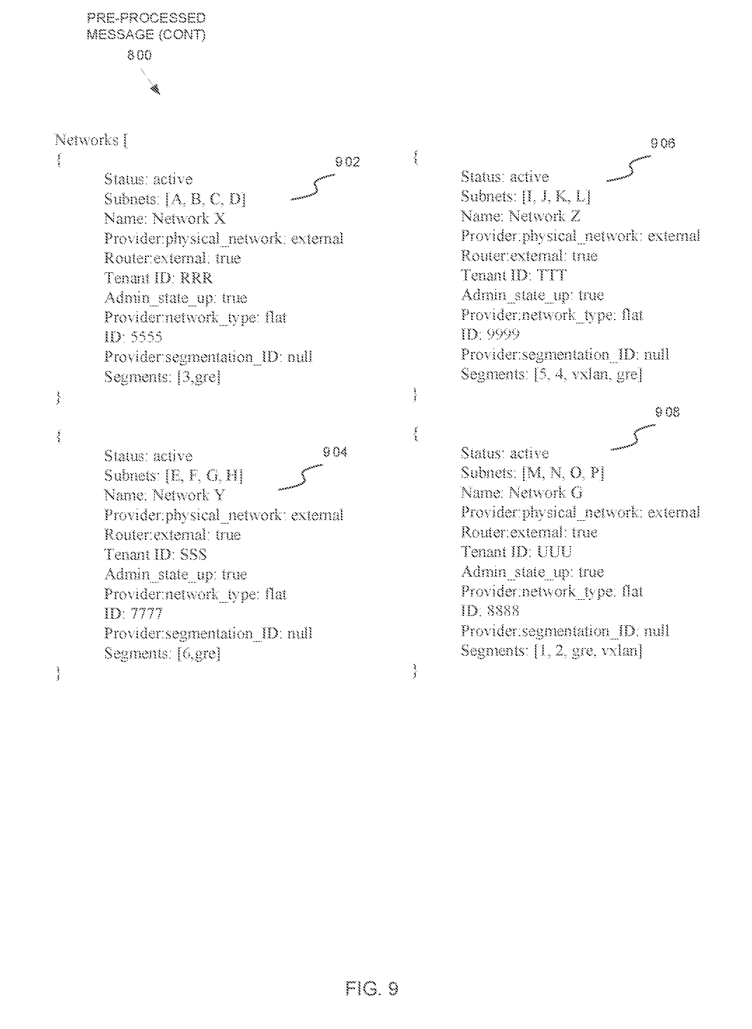

The formatter 120 can also output a pre-processed message. The pre-processed message can include various metadata that is added to the non-normalized message. Examples of the various added metadata include a timestamp when the message is output, status of message (e.g., success or fail), source of the message, etc. For example, the source of the message can include host identification (ID), port number, name of vendor for the network element that is being output, resource data, etc. The resource data can include type of protocol for outputting the message (e.g., Representational State Transfer (REST) protocol), scheme (e.g., Hypertext Transfer Protocol (HTTP)), etc. Additionally, a pre-processed message can be modified to filter out one or more fields from the non-normalized message. For example, a network management tool that is receiving and processing the message may not need field A and field B. Accordingly, the formatter 120 can remove field A and field B from the message. Such a message can be part of pre-processed messages 132 being output from the formatter 120. An example of the pre-processed messages 132 is depicted in FIGS. 8-9 (which is further described below).

The formatter 120 can output a partially normalized message. The partially normalized message can include one or more perspectives and one or more relations that is derived from the normalized inventory stored in the normalized inventory 112. A perspective can be one (of possibly several) views of a network element. For example, an OpenStack technology type may characterize a hypervisor as having properties A, B, and C, whereas a Contrail technology type may characterize a hypervisor as having properties D, E, and F. Also, the process of transforming the non-normalized, raw, technology specific messages to normalized messages for the messages can be incremental. The process can start with the non-normalized, raw, technology specific message. The non-normalized message can then be wrapped to include metadata to create a pre-processed message (see example of a pre-processed message in FIGS. 8-9 (which is further described below). The pre-processed message can then be transformed into a partially normalized message that includes the perspectives and relations of the network elements. The different perspectives can be combined into a same entity. A fully normalized update (e.g., add, update, delete, etc.) can then be created based on a difference between the partially normalized message and the pre-processed message. Such a message can be part of partially normalized messages 134 being output from the formatter 120. An example of the partially normalized messages 134 is depicted in FIG. 1 (which is further described below).

Additionally, the normalized output generator 115 can output fully normalized updates 136 from the normalized inventory 112. In some embodiments, the normalized output generator 115 outputs the a fully normalized update 136 in response to any changes or modifications to the simulated network or network element in the simulated network. For example, if a network element is added, modified, or deleted, the normalized data output manager 116 can output the normalized data related to the modification. For instance, if a network element is added, the normalized data output manager 116 outputs the set of normalized attributes for this added network element. In another example, if relations among the network elements are added or deleted, the normalized data output manager 116 can output normalized data about the network elements affected by the change in relations. Alternatively or in addition, the normalized output generator 115 can output the normalized data as a message in response to a query of polling request from a network management tool or system (similar to the non-normalized message 130, the pre-processed message 132, or the partially normalized message 134, as described above).

### Example Scenario

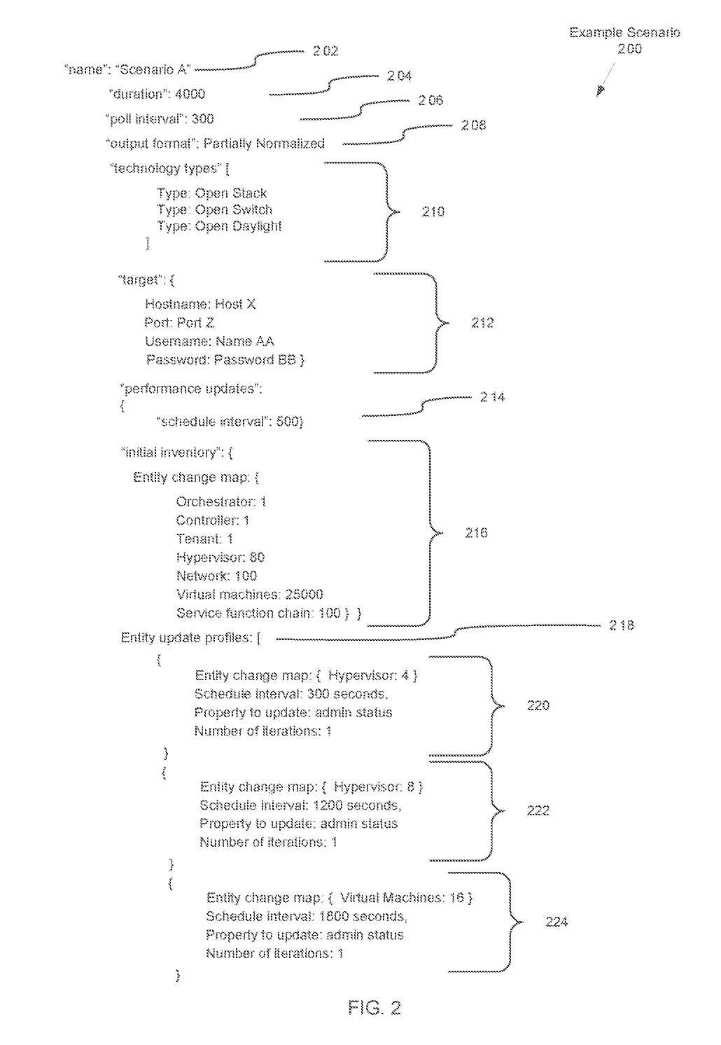

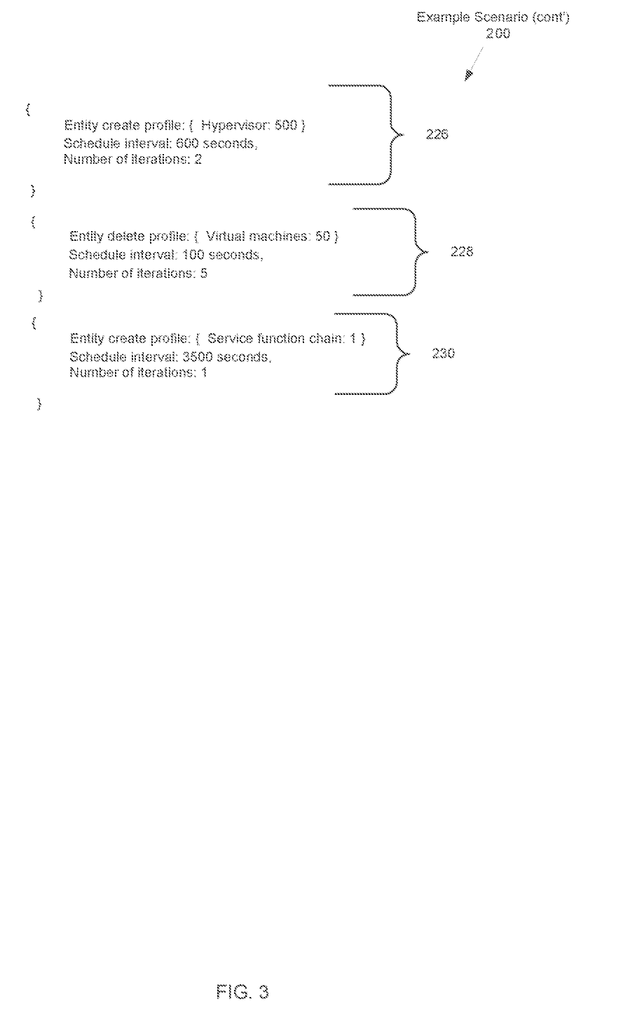

In some embodiments, a network simulation can be initiated and controlled by scenarios. To illustrate, FIGS. 2-3 depict an example scenario that is input into a network simulation, according to some embodiments. FIGS. 2-3 depicts an example scenario 200 that is based on a Yet Another Markup Language (YAML) format. In other embodiments, other types of formats, such as extensible markup language (XML), can be used to define scenarios to be input for network simulation.

YAML text 202 defines a name of the example scenario 200, which is defined as “Scenario A.” YAML text 204 defines a duration of 4000 seconds, which is the time the Scenario A is executed by a network simulator. YAML text 206 defines a poll interval of 300 seconds, which defines that data is published (output) from the network simulator every 300 seconds. YAML text 208 defines an output format for the data being published from the network simulator. In this example, the output format is partially normalized, which includes data output from a perspective for a particular technology type. Other types of output formats can be normalized and non-normalized.

YAML text 210 defines the different technology types that are to be simulated. In this example, the YAML text 210 defines three technology types—open stack, open vswitch, and open daylight. A scenario can define one or more technology types to be simulated. YAML text 212 defines where the data output from the network simulator is published. In this example, the data output is to a Java Message Service (JMS) queue. The YAML text 212 defines that the JMS queue is defined to be hosted by Host X, output to Port Z, and having a username and password of Name AA and Password BB, respectively. In another example, the data output can be to a file(s) on disk or storage.

YAML text 214 defines how often performance updates of the network simulator are output. In this example, performance updates are output every 500 seconds. YAML text 216 defines the initial state of the simulated network. In this example, the network element or entities to be included in the network simulation are one orchestrator, one controller, one tenant, 80 hypervisors, 100 networks, 25000 virtual machines, and 100 service function chains. Some of these network entities can be comprised of multiple individual network elements. To illustrate, an example service function chain is depicted in FIG. 7, which is further described below.

YAML text 218 defines changes, creations, and deletions to the network elements or entities during the network simulation. In some embodiments, the particular network elements or entities changed, created, and/or deleted during network simulation can be randomly determined. For example, the example scenario 200 can define a number of hypervisors to be changed from operational to non-operational. However, selections of which hypervisors to be changed can be randomly determined. The YAML text 218 includes six different changes, creations, and deletions to the network during simulation—defined by YAML text 220, YAML text 222, YAML text 224, YAML text 226, YAML text 228, and YAML text 230.

The YAML text 220 includes instructions to change the status of four hypervisors at the 300 second time point of the network simulation. In this example, the property of the hypervisor to be changed is the admin status, which is toggled between operation and non-operational. For instance, if the current admin status is operational, the change causes the admin status to be non-operational. The YAML text 220 also defines that these changes are to occur once—iteration is set to one.

The YAML text 222 includes instructions to change the status of eight hypervisors. These changes are scheduled to occur 1200 seconds from the start of the network simulation. There may be at least some overlap between the four hypervisors in the YAML text 220 and the eight hypervisors in the YAML text 222. In this example, the property of the hypervisor to be changed is also the admin status, which is toggled between operation and non-operational. The YAML text 222 also defines that these changes are to occur once—iteration is set to one.

The YAML text 224 includes instructions to change the status of 16 virtual machines. These changes are scheduled to occur 1600 seconds from the start of the network simulation. In this example, the property of the virtual machine to be changed is also the admin status, which is toggled between operation and non-operational. The YAML text 224 also defines that these changes are to occur once—iteration is set to one.

FIG. 3 continues a depiction of the example scenario 200.

YAML text 226 includes instructions to create 500 hypervisors that are added to the network simulation. These creations are scheduled to occur 600 seconds from the start of the network simulation. The YAML text 226 also defines that these creations are to occur twice—iteration is set to two. Therefore, a first group of 500 hypervisors is created after 600 seconds, and a second group of 500 hypervisors is created after 1200 seconds.

YAML text 228 includes instructions to delete 50 virtual machines from the network simulation. These deletions are scheduled to occur 100 seconds from the start of the network simulation. The YAML text 228 also defines that these deletions are to occur five times—iteration is set to five. Therefore, a first group of 50 virtual machines is deleted after 100 seconds, a second group of 50 virtual machines is deleted after 200 seconds, a third group of 50 virtual machines is deleted after 300 seconds, a fourth group of 50 virtual machines is deleted after 400 seconds, and a fifth group of 50 virtual machines is deleted after 500 seconds.

YAML text 230 includes instructions to create one service function chain to be added to the network simulation. This creation is scheduled to occur 3500 seconds from the start of the network simulation. The YAML text 230 also defines that this creation is to occur once—iteration is set to one.

### Example Operations for Creating a Network Element

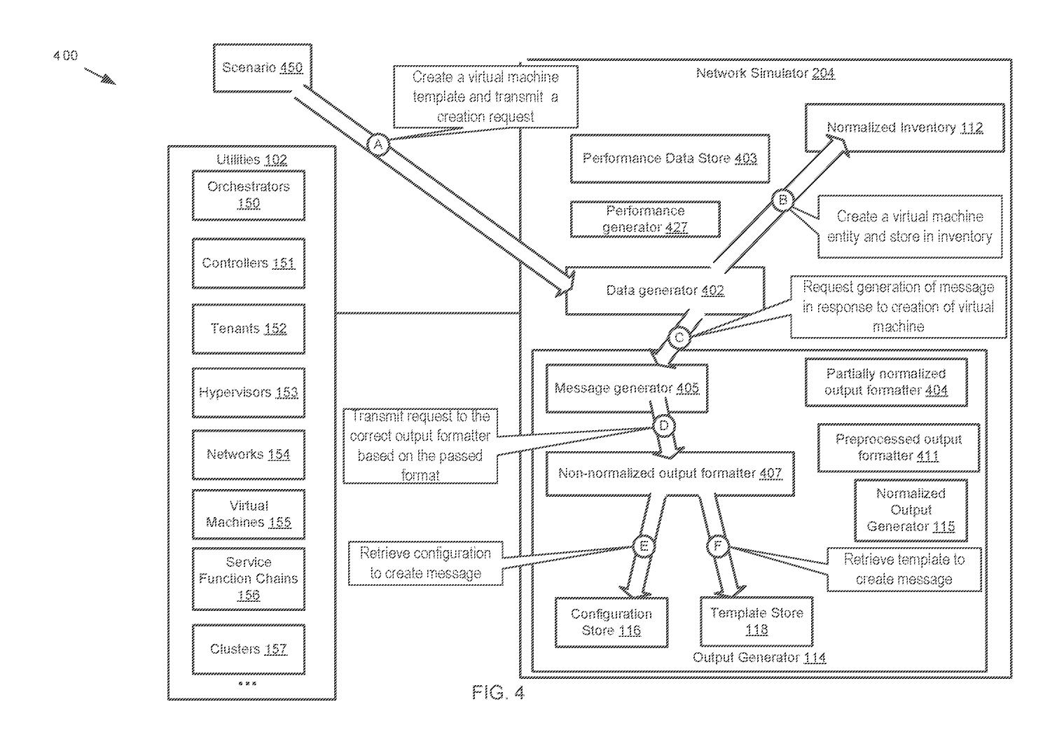

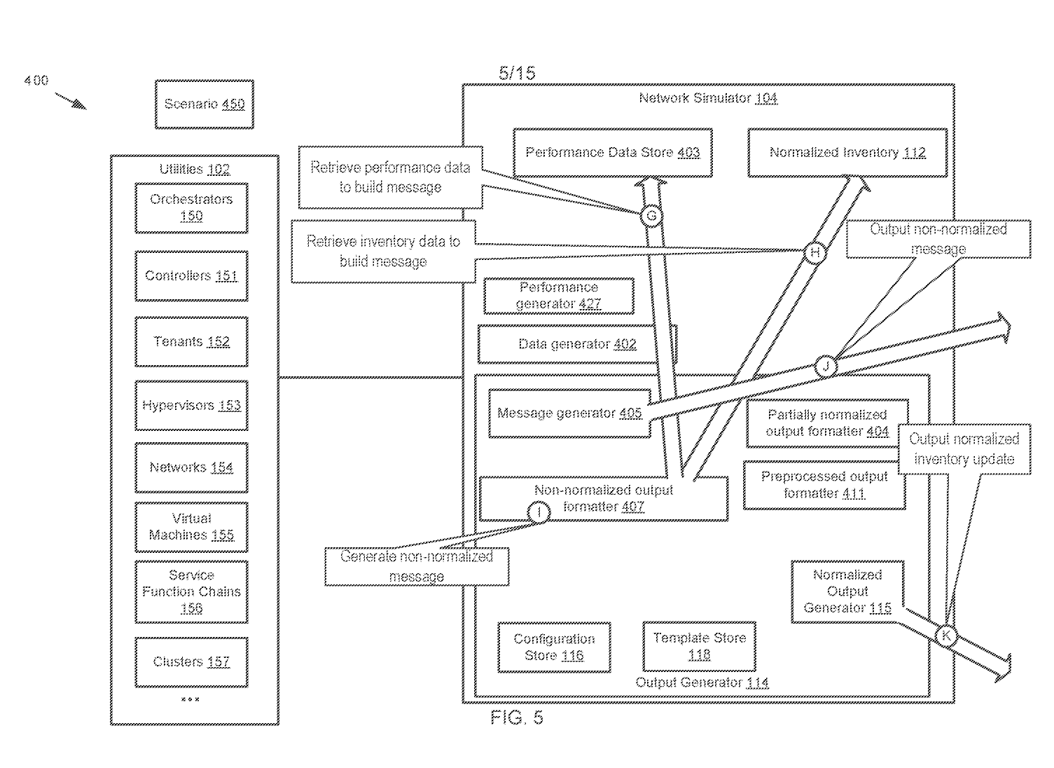

FIGS. 4-5 depicts a more detailed diagram of example operations and communication by components of an example system architecture in response to creating a network element for a technology agnostic network simulation, according to some embodiments. FIGS. 4-5 depict a more detailed block diagram of the example system architecture depicted in FIG. 1. Like the system 100 of FIG. 1, a system 400 includes the utilities 102 and the network simulator 104. Also like the system 100 of FIG. 1, the network simulator 104 in the system 400 includes the normalized inventory 112 and the output generator 114, which includes the normalized output generator 115, the configuration store 116 and the template store 118.

The system 400 depicts a more detailed example embodiment of the network simulator 204. In addition to the elements depicted in FIG. 1, the network simulator 204 also includes a data generator 402 and a performance data store 403. The system 400 depicts a more detailed example embodiment of the output generator 214. The formatter 120 of FIG. 1 is composed of a message generator 405, a non-normalized output formatter 407, a partially normalized output formatter 404, and a preprocessed output formatter 411 (as depicted in FIGS. 4-5).

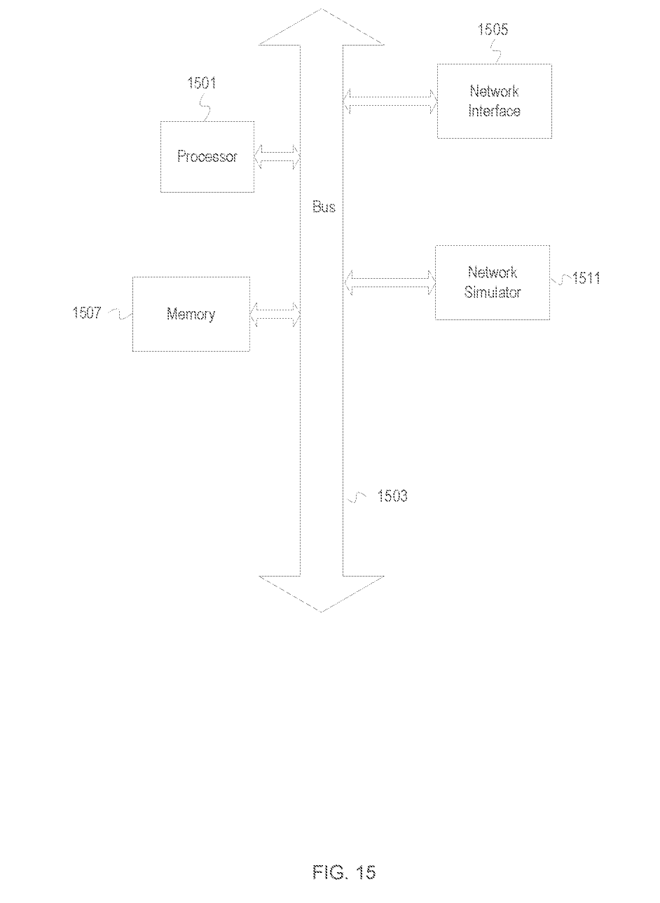

The network simulator 104, the data generator 102, the output generator 114, the message generator 405, the non-normalized output formatter 407, the partially normalized output formatter 404, the preprocessed output formatter 411, and the normalized output generator 115 can be software, firmware, hardware, or a combination thereof. For example, one or more of these components can be software executing on processor(s) in a computer device. One example of such a computer device is depicted in FIG. 15, which is further described below.

FIGS. 4-5 are annotated with a series of letters A-K. These letters represent operational stages. Although these stages are ordered for this example, the stages illustrate one example to aid in understanding this disclosure and should not be used to limit the claims. Subject matter falling within the scope of the claims can vary with respect to the order and some of the operations. In this example, the operational stages depict creation of a virtual machine as part of a simulate network based on input by a scenario into the network simulator 104 and output of a message during network simulation.

At stage A, the data generator 402 detects receipt of a scenario 450. For example, the scenario can be input from a user that needs execution of a specifically defined simulation. For example, a user can be testing their network management tool that processes messages being output during the simulation to verify that their tool is operating correctly in response to the specifically defined scenario. As described above in reference to the example scenario 200 of FIGS. 2-3, the scenario can define the length of the simulation, how often to poll network elements in the simulated network, the technology types of the different network elements, the output format (e.g., non-normalized, partially normalized, normalized, etc.). The scenario can also define the initial number and types of network elements in the simulated network, and changes to the network elements and simulated network during simulation. Changes can include adding, deleting, and modifying a network element. The scenario can also include when and how often these changes occur.

In response to detecting the scenario 450, the data generator 402 can parse the scenario 450 to locate the various declarations to determine how to create and simulate the network. For example, the data generator 402 can determine the type, number, and technology type of each network element to be included initially in the simulated network. With reference to the example scenario 200 of FIGS. 2-3, the data generator 402 can parse the YAML text 216 to determine that the simulated network initially includes one orchestrator, one controller, one tenant, 80 hypervisors, 100 networks, 25000 virtual machines, and 100 service function chains. For each type of network element, the data generator 402 retrieves the create function and entity template for the associated utility from the utilities 102. The create function and entity template can be different for different types of network elements (e.g., hypervisor, virtual machine, etc.). For example, the entity template can define the types of attributes needed for the given type of network element.

At stage B, the data generator 402 can then instantiate and store an instance of the entity template in the normalized inventory 112. The data generator 402 can instantiate and store an instance of the entity template for each of the number of network elements of a given type. With reference to the example scenario 200 of FIGS. 2-3, the data generator 402 can instantiate one instance of the entity template for an orchestrator, one instance of the entity template for a controller, one instance of the entity template for a tenant, 80 instances of the entity template for the hypervisor, 100 instances of the entity template for the network, 25000 instances of the entity template for the virtual machine, and 100 instances of the entity template for the service function chain. Although not shown, the data generator 402 can also create and store performance data in the performance data store 403 for each of the instances stored in the normalized inventory 112. The performance data can be specific to the type of network element. Different types of network elements can have different performance data. Examples of performance data for a hypervisor can include processor utilization, memory utilization, storage disk utilization, etc. Examples of performance data for a network interface can include number of bytes input/output, number of packets input/output, number of packets dropped, packet errors, etc. In some embodiments, the data generator 402 can randomly generate the performance data for each of the instances stored in the normalized inventory 112. For example, the data generator 402 can generate and store these values in the performance data store 403 at the time the instances are stored in the normalized inventory 112.

At stage C, the data generator 402 requests generation of a message in response to creation of the virtual machine. The message generator 405 receives the request. The request can include identification of the network element that has been created and a format of the message to be output.

At stage D, the message generator 405 then transmits the request to the correct output formatter based on the format identified in the request. For example, the requested format can be non-normalized, partially normalized, or pre-processed. If the format is non-normalized, the message generator 405 forwards the request to the non-normalized output formatter 407. If the format is partially normalized, the message generator 405 forward the request to the partially normalized output formatter 404. If the formatter is pre-processed, the message generator 405 forwards the request to the pre-processed output formatter 411. In this example, the requested format is non-normalized. Therefore, the message generator 405 forwards the request to the non-normalized output formatter 407.

At stage E, the non-normalized output formatter 407 retrieves the configuration for this network element having a given technology type from the configuration store 116. Each pair of configuration and template can be specific to a given technology type for a given type of network element. Therefore, the non-normalized output formatter 407 retrieves the configuration from the configuration store 116 based on the type of network element and its technology type. The configuration defines how to populate data that is defined by the associated template, which is included in building the message.

At stage F, the non-normalized output formatter 407 retrieves the template for this network element having a given technology type from the template store 118. The non-normalized output formatter 407 retrieves the template from the template store 118 based on the type of network element and its technology type. The template defines what data is to be included in building the message.

Stages G-K are depicted in FIG. 5, which is now described.

At stage G, the non-normalized output formatter 407 retrieves performance data for the network element that has been created from the performance data store 403. For example, the non-normalized output formatter 407 can retrieve the performance data based on an identification assigned to the network element by the data generator 402 during initial creation of the instance of the network element.

At stage H, the non-normalized output formatter 407 retrieves normalized data defining the network element that has been created from the normalized inventory 112. For example, the non-normalized output formatter 407 can retrieve the normalized data based on an identification assigned to the network element by the data generator 402 during initial creation of the instance of the network element.

At stage I, the non-normalized output formatter 407 generates the non-normalized message. The message includes attributes that are non-normalized (specific to a technology type). These attributes that are specific to a technology type are not stored in the normalized inventory 112. Rather, the message generator 405 can create and assign values to these attributes. The message generator 405 can create and assign values to these attributes based on actual messages captured from an actual network in operation. In some embodiments, the message generator 405 can randomly assign these values for the different network elements whose attributes are included in the message.

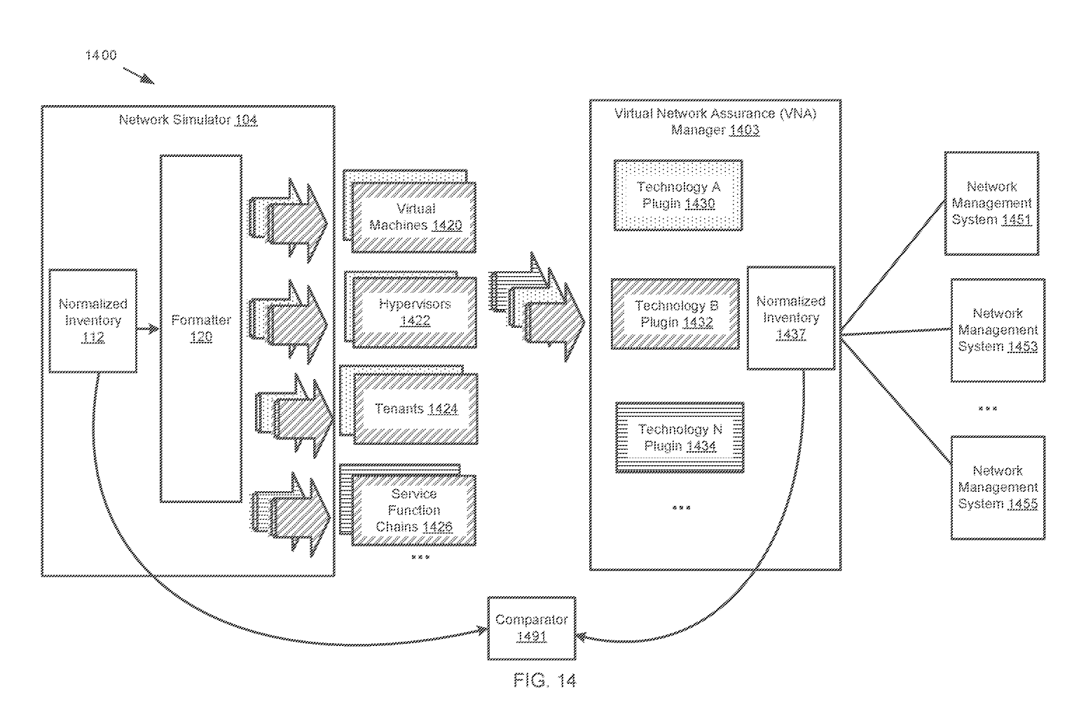

At stage J, the message generator 405 outputs the message based on the timing defined in the scenario 450. With reference to the example scenario 200 of FIGS. 2-3, the message generator 405 outputs a message at each polling interval, which is defined as every 300 seconds (see YAML text 206). The message generator 405 can output the message to various devices, communication buses (e.g., API bus), etc. As further described below in reference to FIG. 14, the message generator 405 can output the message to a plugin within a virtual network analyzer. Alternatively, the message generator 405 can output the message directly to one or more of the network management systems.

At stage K, the normalized output generator 115 outputs a normalized inventory update. For example, the data generator 402 can notify the normalized output generator 115 any time the simulated network is updated. These updates can include a change in an existing network element, adding a new network element, or deleting an existing network element. The normalized inventory update can include identification of the network element being updated, added, or deleted along with any other changes caused by the update. For example, if an existing network element is updated, the normalized inventory update can include identification of the attribute(s) modified and their new values. If a new network element is added, the normalized inventory update can include the other network elements to which the new network element is connected. The normalized output generator 115 can output the message to various devices, communication buses (e.g., API bus), etc.

Stages C-K depict operations and for generation and outputting of a message and normalized inventory update in response to creation of a network element. In some other embodiments, at least some of these operations are not performed each time a network element is created.

### Example Network Element Composed of Network Elements

FIG. 6 depicts an example service function chain created for inputting into a network simulation, according to some embodiments. In this example, a service function chain 602 is composed of other network elements. The service function chain 602 includes a virtual network function 604 and a virtual network function 606. The virtual network function 604 includes a virtual machine 620. The virtual network function 606 includes a virtual machine 622 and a virtual machine 624. The service function chain 602 also includes a network 608, a network 610, and a network 612. The network 608 includes a subnet 614. The network 610 includes a subnet 616. The network 612 includes a subnet 618. The service function chain 602 also includes an interface 630, an interface 632, an interface 634, an interface 636, an interface 638, and an interface 640. The virtual machine 620 is connected to the subnet 614 through the interface 630. The virtual machine 620 is connected to the subnet 616 through the interface 632. The virtual machine 622 is connected to the subnet 616 through the interface 634. The virtual machine 622 is connected to the subnet 618 through the interface 638. The virtual machine 624 is connected to the subnet 616 through the interface 636. The virtual machine 624 is connected to the subnet 618 through the interface 640.

The service function chain 602 is composed of two virtual network functions, three virtual machines, three networks, a subnet in each of the networks, and six interfaces for connecting the virtual machines to the subnets. In some embodiments, quantities of each of these network elements within a network element are randomly determined. Also, connectivity among these network elements can be randomly determined. For example, the service function chain 602 can be composed of a different number of virtual network functions, virtual machines, networks, interfaces, etc.

### Example Messages Output During Network Simulation

FIG. 7 depicts an example non-normalized message, according to some embodiments. In particular, FIG. 7 depicts a non-normalized message 700 that includes technology-specific data for the various networks in the simulated network. The non-normalized message 700 can be output from the network simulation in response to a request or polling from a network management tool or system. In this example, the non-normalized message 700 includes a data set for four different networks. A data set 702 is for a network X. A data set 704 is for a network Y. A data set 706 is for a network Z. A data set 708 is for a network G. In this example, the data set for each network includes attributes and status of their respective network.

The data set 702 comprises a first field that includes a status of the network X set to active and a second field that includes the subnets within the network X—subnets A-D. The data set 702 also comprises a third field that includes the name of the network—network X and a fourth field that includes an attribute of the physical network—external. The data set 702 comprises a fifth field that includes a Boolean value indicating whether there is an external router. In this example, the Boolean value is set to true. The data set 702 comprises a sixth field that includes a tenant ID having a value of DDD and a seventh field that includes a Boolean value indicating whether the administrate state is up. In this example, the Boolean value is set to true. The data set 702 comprises an eighth field that includes a Maximum Transmission Unit (MTU) size for the network, which is set to 0. The data set 702 comprises a ninth field that includes a Boolean value indicating whether the network X is shared or not. In this example, the Boolean value is set to false. The data set 702 comprises a tenth field that includes the network type, which is set to flat, and an eleventh field that includes an ID for the network X, which is set to 5555. The data set 702 comprises a twelfth field that includes the value of a segmentation ID for the network X, which is set to NULL. The data set 702 comprises a thirteenth field that includes the number and type of segments. In this example, these values are set to 3 and GRE, respectively.

The data set 704 comprises a first field that includes a status of the network Y set to active and a second field that includes the subnets within the network Y—subnets E-H. The data set 704 also comprises a third field that includes the name of the network—network Y and a fourth field that includes an attribute of the physical network—external. The data set 704 comprises a fifth field that includes a Boolean value indicating whether there is an external router. In this example, the Boolean value is set to true. The data set 704 comprises a sixth field that includes a tenant ID having a value of SSS and a seventh field that includes a Boolean value indicating whether the administrate state is up. In this example, the Boolean value is set to true. The data set 704 comprises an eighth field that includes a MTU size for the network, which is set to 0. The data set 704 comprises a ninth field that includes a Boolean value indicating whether the network Y is shared or not. In this example, the Boolean value is set to false. The data set 704 comprises a tenth field that includes the network type, which is set to flat, and an eleventh field that includes an ID for the network Y, which is set to 7777. The data set 704 comprises a twelfth field that includes the value of a segmentation ID for the network Y, which is set to NULL. The data set 704 comprises a thirteenth field that includes the number and type of segments. In this example, these values are set to 6 and GRE, respectively.

The data set 706 comprises a first field that includes a status of the network Z set to active and a second field that includes the subnets within the network Z—subnets I-L. The data set 706 also comprises a third field that includes the name of the network—network Z and a fourth field that includes an attribute of the physical network—external. The data set 706 comprises a fifth field that includes a Boolean value indicating whether there is an external router. In this example, the Boolean value is set to true. The data set 706 comprises a sixth field that includes a tenant ID having a value of TTT and a seventh field that includes a Boolean value indicating whether the administrate state is up. In this example, the Boolean value is set to true. The data set 706 comprises an eighth field that includes a MTU size for the network, which is set to 0. The data set 706 comprises a ninth field that includes a Boolean value indicating whether the network Z is shared or not. In this example, the Boolean value is set to false. The data set 706 comprises a tenth field that includes the network type, which is set to flat, and an eleventh field that includes an ID for the network Z, which is set to 9999. The data set 706 comprises a twelfth field that includes the value of a segmentation ID for the network Z, which is set to NULL. The data set 706 comprises a thirteenth field that includes the number and type of segments. In this example, there are five segments that are of type VXLAN and four segments that are of type GRE.

The data set 708 comprises a first field that includes a status of the network G set to active and a second field that includes the subnets within the network G—subnets M-P. The data set 708 also comprises a third field that includes the name of the network—network G and a fourth field that includes an attribute of the physical network—external. The data set 708 comprises a fifth field that includes a Boolean value indicating whether there is an external router. In this example, the Boolean value is set to true. The data set 708 comprises a sixth field that includes a tenant ID having a value of UUU and a seventh field that includes a Boolean value indicating whether the administrate state is up. In this example, the Boolean value is set to true. The data set 708 comprises an eighth field that includes a MTU size for the network, which is set to 0. The data set 708 comprises a ninth field that includes a Boolean value indicating whether the network G is shared or not. In this example, the Boolean value is set to false. The data set 708 comprises a tenth field that includes the network type, which is set to flat, and an eleventh field that includes an ID for the network G, which is set to 8888. The data set 708 comprises a twelfth field that includes the value of a segmentation ID for the network G, which is set to NULL. The data set 708 comprises a thirteenth field that includes the number and type of segments. In this example, there is one segment that is of type GRE and two segments that are of type VXLAN.

FIGS. 8-9 depict an example pre-processed message, according to some embodiments. In particular, FIGS. 8-9 depict a pre-processed message 800 that appends metadata that is included with the non-normalized message. Also, one or more fields of the non-normalized message can be filtered as part of the pre-processed message. The pre-processed message 800 can be output from the network simulation in response to a request or polling from a network management tool or system. In this example, the pre-processed message 800 includes metadata 802 (depicted in FIG. 8) and a modified non-normalized message, which includes data sets 902-908 (depicted in FIG. 9). The data sets 902-908 are modified versions of the data sets 802-810, respectively (as further described below).

The metadata 802 can include various data that may not be included with the data sets 902-910 but provides additional information about the message and the network elements whose status, attributes, etc. are being included in the message. The metadata 802 includes a timestamp having a value of 1234 and a type of message having a value of inventory. The metadata 802 also includes a status of the message, which includes a code and a reason for the message. In this example, the code is set to a value of success, and the reasons is set to “open collector poll successful.” The metadata 802 includes a source of the message. The source includes a host ID having a value of 1.1.3.1 and a port number having a value of 9696. The source also includes a version of the message having a value of DDD and name of a vendor of the network element. In this example, the network element is a network and the vendor is OpenSource. The source includes a name for the technology that generated the data, which is OpenStack. The source also includes an ID of the type of component (the type of network element). In this example, the ID is 333. The source includes an ID indicating the configuration or component that provided the data. In this example, the tenant ID is 222, and the tenant name is TenantX. The source includes resources used for outputting the message. The resources include type of protocol and scheme for outputting the message, the type of network element, and the Application Programming Interface (API) version used for outputting the message. In this example, the type of protocol is REST. The type of scheme is HTTP. The type of network element is networks, and the API version is v2.0.

The data sets 902-908 are modified versions of the data sets 802-810, respectively. In this example, the data sets 902-908 are the same as the data sets 802-810 except that two fields have been removed from each of the data sets 902-908. In this example, the size of the MTU and whether the network is shared has been removed from each of the data sets 902-908.

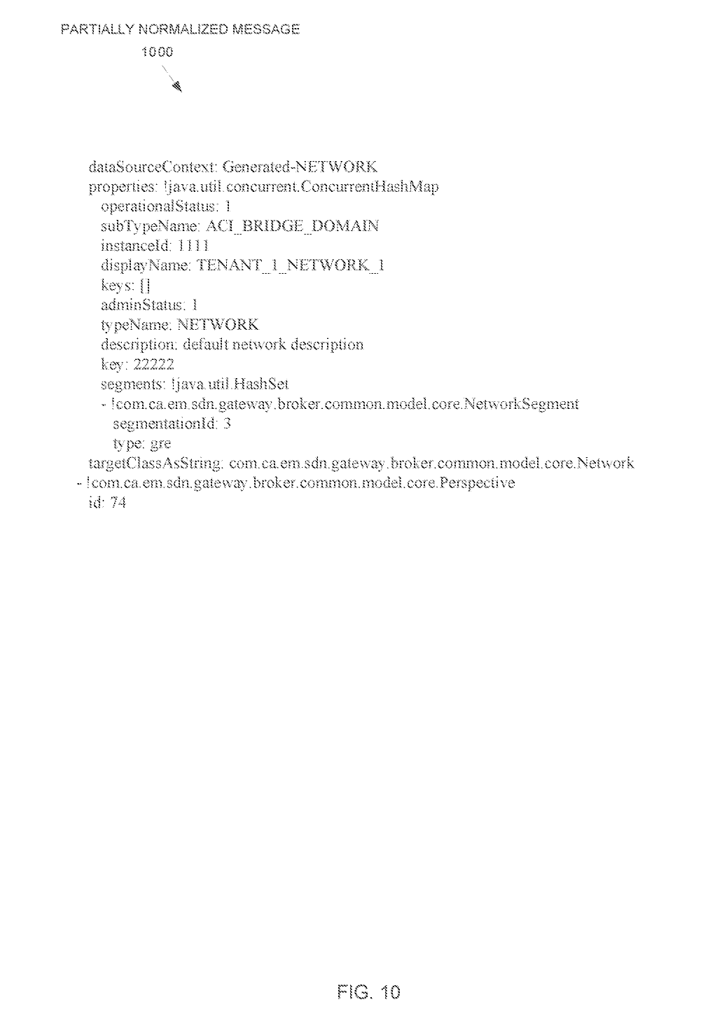

FIG. 10 depicts an example partially normalized message, according to some embodiments. A partially normalized message 1000 is a normalized version of data output from the network simulator 104 that is customized for a specific type of network management system. For example, the normalized version of the data can be for a specific vendor provides a network management system or a specific product that includes the network management system. Accordingly, partially normalized message A can be for vendor X of a network management system, and partially normalized message B can be for vendor Y of a different network management system. This allows different network management systems to process the messages being output from the network simulator 104. The partially normalized message represents a specific format of the simulated network data that may be consumed by a particular part of a client application. In order to isolate parts of a larger client application (for the purpose of testing discrete subsystems of a larger application), the network simulator may generate partially normalized messages that can be consumed by a subsystem. Once these partially normalized messages have been consumed, a process may be used to validate that the subsystem processed the partially normalized message in the expected manor, thereby producing expected results.

### Example Operations

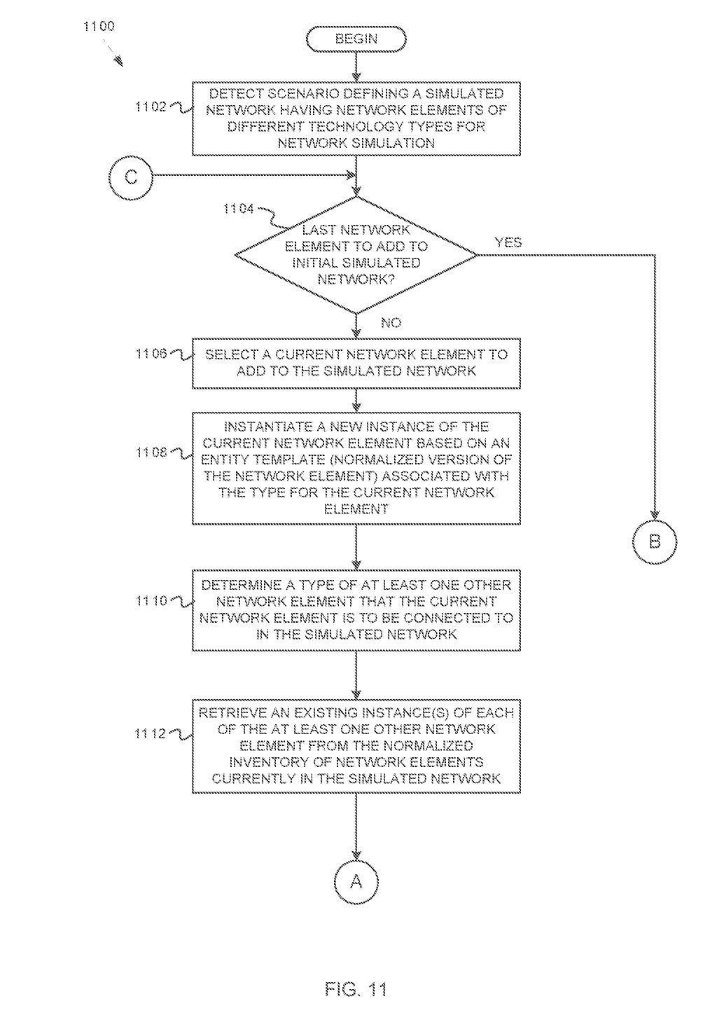

FIGS. 11-13 depict flowcharts for a technology agnostic network simulation, according to some embodiments. Flowcharts 1100-1300 of FIGS. 11-13 are described with reference to the system 400 depicted in FIGS. 4-5. Operations of the flowcharts 1100-1300 can be performed by software, firmware, hardware or a combination thereof. Operations of the flowcharts 1100-1300 continue among each other through transition points A-C (as further described below). The operations of the flowchart 1100 start at block 1102.

A scenario defining a simulated network having network elements of different technology types for network simulation is detected (1102). With reference to FIGS. 4-5, the data generator 402 can detect the scenario 450. As described above, the scenario 450 can define the length of the simulation, how often to poll network elements in the simulated network, the technology types of the different network elements, the output format (e.g., non-normalized, partially normalized, normalized, etc.). The scenario 450 can also define the initial number and types of network elements in the simulated network, and changes to the network elements and simulated network during simulation. Changes can include adding, deleting, and modifying a network element. The scenario 450 can also define when and how often these changes occur. In response to detecting the scenario 450, the data generator 402 can parse the scenario 450 to determine the type, number, and technology type of each network element to be included initially in the simulated network. With reference to the example scenario 200 of FIGS. 2-3, the data generator 402 can parse the YAML text 216 to determine that the simulated network initially includes one orchestrator, one controller, one tenant, 80 hypervisors, 100 networks, 25000 virtual machines, and 100 service function chains.

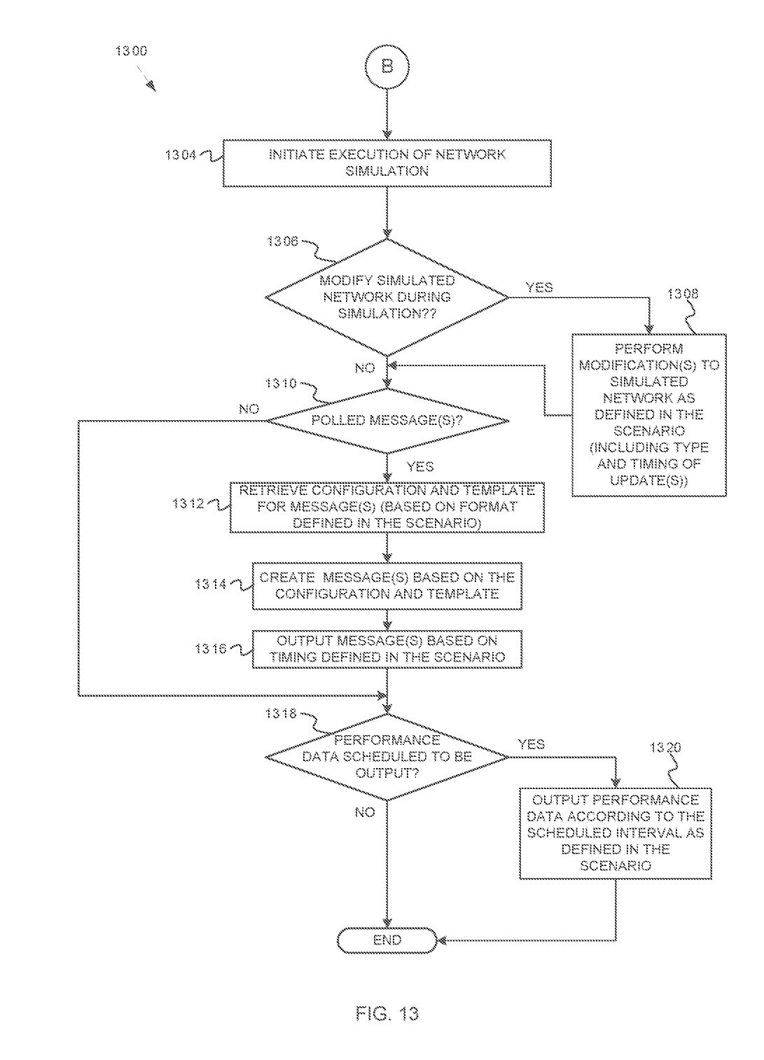

A determination is made of whether the last network element has been added to the initial simulated network (1104). With reference to FIGS. 4-5, the data generator 402 can make this determination. With reference to the example scenario 200 of FIGS. 2-3, the data generator 402 determines whether each network element defined in the YAML text 216 has been instantiated and stored in the normalized inventory 112. If the last network element has been added to the initial simulated network, operations of the flowchart 1100 continue at transition point B, which continues at transition point B in FIG. 13, which is further described below. If the last network element has not been added to the initial simulated network, operations of the flowchart 1100 continue at 1106.

A current network element to add to the simulated network is selected (1106). With reference to FIGS. 4-5, the data generator 402 can select a current network element to add based on an order defined in the scenario 450. With reference to the example scenario 200 of FIGS. 2-3, the data generator 402 can add the one instance of the orchestrator, and then add the one instance of a controller, etc. until 100 service function chains have been added.

A new instance of the current network element is instantiated based on an entity template associated with the type of the current network element (1108). The entity template represents a normalized version of the network element. Accordingly, the new instance comprises a technology agnostic representation of the network element. For example, the new instance includes attributes that are common or applicable to any technology type for the network element. Therefore, no technology specific attributes are included in the new instance of the current network element. With reference to FIGS. 4-5, the data generator 402 can retrieve the create function and entity template for the associated utility from the utilities 102. The data generator 402 can then instantiate and store an instance of the entity template in the normalized inventory 112. The instance of the entity template can include a unique ID for this particular instance of the network element. The instance can also include attributes and status of the network element. As part of instantiation, the data generator 402 can assign initial values to the attributes and status of the various attributes. In some embodiments, the data generator 402 can randomly assign these initial values. Also, after instantiating the new instance and populating its initial values, the data generator 402 can store the new instance in the normalized inventory 112.

A type of at least one other network element that the current network element is to be connected in the simulated network is determined (1110). With reference to FIGS. 4-5, the data generator 402 can make this determination. Each instance of a network element from an entity template can define what other network elements the network element is to be connected in the network. For example, an entity template for a virtual machine includes an indication that the virtual machine is to be connected to its associated hypervisor.

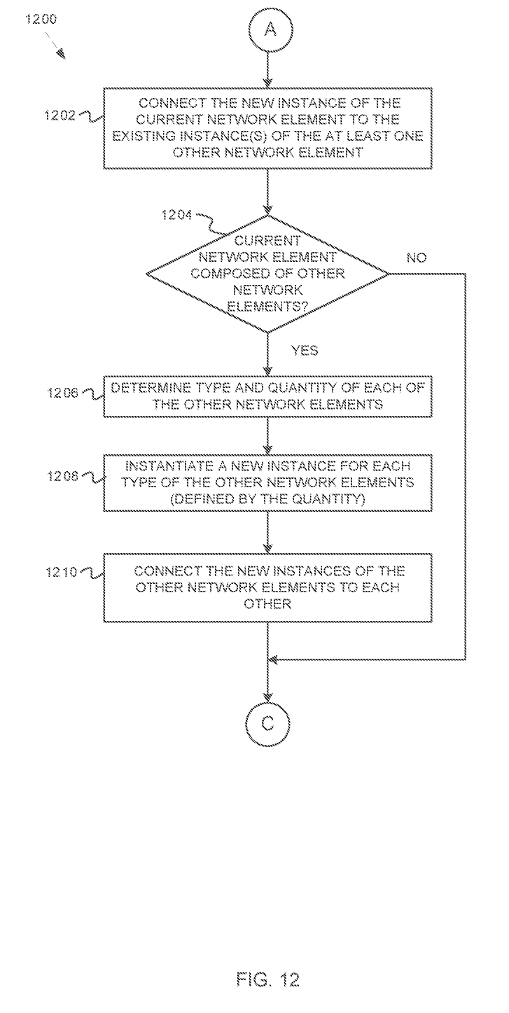

An existing instance(s) of each of the at least one other network element (to which the current network is to be connected) is retrieved from the normalized inventory of network elements currently in the simulated network (1112). With reference to FIGS. 4-5, the data generator 402 can retrieve the existing instance(s) for each of the at least one other network elements from the normalized inventory 112. In some embodiments, the data generator 402 can randomly retrieve the existing instance(s) of the at least one other network element. In other embodiments, the data generator 402 can retrieve the existing instance that is most recently stored in the normalized inventory 112. Alternatively, the data generator 402 can retrieve the existing instance that is least recently stored in the normalized inventory 112. Operations of the flowchart 1100 continue at transition point A, which continue at transition point A in the flowchart 1200 of FIG. 12.

Operations of the flowchart 1200 of FIG. 12 are now described. From transition point A, operations of the flowchart 1200 continue at block 1202.

The new instance of the current network element is connected to the existing instance(s) of at least one other network element retrieved from the normalized inventory (1202). With reference to FIGS. 4-5, the data generator 402 can connect the new instance to the existing instance(s) retrieved from the normalized inventory 112. The data generator 402 can connect by creating a relation object to define connectivity between each new instance and a given existing instance.

A determination is made of whether the current network element is composed of other network elements (1204). With reference to FIGS. 4-5, the data generator 402 can make this determination. Each utility class in the utilities 102 can include an associated create function that defines operations to be executed as part of instantiating a network element. These operations can include an operation to instantiate other network elements that are part of the current network element. With reference to the example depicted in FIG. 6 (described above), a new instance of a service function chain can include create function to instantiate two virtual network functions, three instances of a network, three instances of a subnet, the instances of a virtual machine, and six instances of an interface. Accordingly, the data generator 402 can make this determination based on whether the create function associated with the network being instantiated includes operations to instantiate other network elements that are within the current network element that has been instantiated. In some embodiments, a relation object can be created to define this connectivity between a network element and other network elements of which the network element is composed. For example, for a virtual machine that includes an interface, a relation object can be defined as a virtual machine IS_COMPOSED_OF an interface. If the current network element is composed of other network elements, operations of the flowchart 1200 continue at 1206. If the current network element is not composed of other network elements, operations of the flowchart 1200 continue at transition point C, which continues at transition point C in the flowchart 1100 of FIG. 11.

A type and quantity of each of the other network elements that are part of the current network element being instantiated are determined (1206). With reference to FIGS. 4-5, the data generator 402 can make this determination. The quantity and type of each of the other network elements can be defined by the create function associated with the current network element, as defined in the particular utility for the current network element within the utilities 102. In some embodiments, instead of being defined in the create function, the type and/or the quantity of each of the other network elements can be randomly determined. With reference to the example depicted in FIG. 6, the create function for the service function chain can include operations to instantiate a virtual network function with at least one virtual machine. However, the quantity of virtual machines in each virtual network function can be randomly determined.

A new instance is instantiated for each type of the other network elements included in the current network element (as defined by the quantity for each of the other network elements) (1208). With reference to FIGS. 4-5, the data generator 402 can instantiate the new instances(s) based on the entity template and create function for the associated network elements in the utilities 102. For each type of other network element, a new instance can be instantiated for each of the number of network elements. For example, with reference to the service function chain 602 depicted in FIG. 6, a new instance would be created for each of the two virtual network functions. A new instance would be created for each of the three networks. A new instance would be created for each of the three subnets. A new instance would be created for each of the three virtual machines, and a new instance would be created for each of the six interfaces. The entity template represents a normalized version of the network element. Therefore, no technology specific attributes are included in the new instance for each type of the other network elements. With reference to FIGS. 4-5, the data generator 402 can retrieve the create function and entity template for the associated utility from the utilities 102. The data generator 402 can then instantiate and store an instance of the entity template in the normalized inventory 112. Each new instance of an entity template can include a unique ID for this particular instance of the network element. The instance can also include attributes and status of the network element. As part of instantiation, the data generator 402 can assign initial values to the attributes and status of the various attributes. In some embodiments, the data generator 402 can randomly assign these initial values. Also, after instantiating the new instance and populating its initial values, the data generator 402 can store the new instances in the normalized inventory 112.

The new instances of the other network elements are connected to each other (1210). With reference to FIGS. 4-5, the data generator 402 can connect the new instances to each other. The data generator 402 can determine this connectivity of the new instances of the other network elements can be defined by the create function associated with the current network element that includes these other network elements, as defined in the particular utility for the current network element within the utilities 102. In addition to connectivity, the create function can define which of these other network elements are part of another one of these other network elements. To illustrate, with reference to the service function chain 602 of FIG. 6, the create function of the service function chain 602 can define that each of three networks is to include a subnet and that the service function chain 602 also includes two virtual network functions. The create function also defines that a first virtual network function is to include one virtual machine and that a second virtual network function is to include two virtual machines. Based on these definitions, the data generator 402 configures the service function chain 602 such that the subnet 614 is within the network 608, the subnet 616 is within the network 610, the subnet 618 is within the network 612. Based on these definitions, the data generator 402 also configures the service function chain 602 such that the virtual machine 620 is within the virtual network function 604 and the virtual machines 622-624 are within the virtual network function 606. The data generator 402 can then connect the virtual machines to the subnets through the interfaces as depicted in FIG. 6. For example, the data generator 402 can create a relation object to define connectivity among the objects. For instance, where the network 610 is composed of the subnet 618, the data generator 402 can create a relation object that defines that network 610 HAS_SUBNET 618.

Also, for any network elements that are included in another network element (e.g., subnet within a network), the data generator 402 can create a relation object to define the relationship between the network element and the network element that is included therein. Also, if a non-normalized message is created, this relationship can be converted into an attribute value for the network elements. For example, a virtual machine network element includes a name of its hypervisor. Operations of the flowchart 1200 continue at transition point C, which continues at transition point C of the flowchart 1100.

From transition point C, which continues at transition point C in the flowchart 1100 of FIG. 11. Transition point C in the flowchart 1100 returns to determine whether the last network element has been added to the initial simulated network at 1104.

Operations of the flowchart 1300 of FIG. 13 are now described. Operations of the flowchart 1300 include operations that occur after creation of the initial simulated network and during the network simulation (as is now described). Operations of the flowchart 1300 can be partitioned into three groups. A first group includes operations related to modifying the simulated network (e.g., adding, deleting, or modifying network elements). A second group includes operations for outputting polled messages on a periodic basis. A third group includes operations for outputting performance data for the network elements in the simulated network. The outputting of performance data can also be performed on a periodic basis. While operations are depicted as occurring sequentially in a given order, at least some of these operations can occur at least partially in parallel and/or in an order that is different from the order depicted in the flowchart 1300. For example, operations for modification of the simulated network can overlap with operations for output of a polled message. In another example, operations for output of a polled message can be performed at a same time or overlap with operations for output of performance data.

From transition point B, operations of the flowchart 1300 continue at 1302.

Execution of the network simulation is initiated (1304). With reference to FIGS. 4-5, the data generator 402 can initiate execution of the network simulation after the initial simulated network has been created. Also, the data generator 402 can control the network simulation based on the declarations in the scenario 450. The network simulation can include modifying, adding, and deleting network elements in the simulated network. The network simulation can also include outputting of periodic polling messages regarding the number, type, and status of network elements in the simulated network according to one or more output formats (e.g., non-normalized, partially normalized, etc.). The network simulation can also include outputting of performance data for one or more network elements. The declarations in the scenario 450 can determine what occurs and timing of these occurrences in the network simulation (as further described below).

A determination is made of whether any modifications to the simulated network are to occur during the simulation (1306). With reference to FIGS. 4-5, the data generator 402 can make this determination based on the declarations defined in the scenario 450. For example, the declarations in the scenario 450 can include adding network element(s) at some time point(s) during the network simulation, deleting network element(s) at some time point(s) during the network simulation, or modifying existing network element(s) at some time point(s) during the network simulation. With reference to the example scenario 200 depicted in FIGS. 2-3, the declarations in the YAML text 220 includes a modification to hypervisor 4 to toggle its admin status from operational to non-operational or vis versa. The YAML text 220 also indicates that this modification is to occur once (iterations defined as one) at the 300 second time point of the network simulation. The declarations in the YAML text 226 includes creation of 500 hypervisors. The YAML text 226 also indicates that this creation is to occur twice (iterations defined as two) at the 600 second time point and the 1200 second time point of the network simulation. The declarations in the YAML text 228 includes deletion of 50 virtual machines. The YAML text 228 also indicates that this deletion is to occur five times (iterations defined as five) at the 100 second time point, the 200 second time point, the 300 second time point, the 400 second time point, and the 500 second time point of the network simulation. The scenario 450 can explicitly define which network elements are to be deleted or modified. Alternatively, the data generator 402 can make this determination. For example, the data generator 402 can randomly select which network elements are to be deleted or modified. When a new network element is added to the simulated network, the data generator 402 can select what other network element(s) that the new network element is to connect in the simulated network (as described above). For example, the data generator 402 can randomly select the other network element(s) that the new network element is to be connected in the simulated network. If there are modifications, operations of the flowchart 1300 continue at 1308. Otherwise, operations of the flowchart 1300 continue at 1310.

Modifications to the simulated network are performed in accordance with the type and timing as defined in the scenario (1308). With reference to FIGS. 4-5, the data generator 402 can perform these modifications by updating the normalized inventory 112 (as described above). For example, the data generator 402 can update an existing network element by updating the instance of this existing network element stored in the normalized inventory 112. The data generator 402 can add a new network element by instantiating an entity template for the network element from the utilities 102 (as described above).

A determination is also made of whether there are any polled messages to be output (1310). With reference to FIGS. 4-5, the data generator 402 can make this determination based on the declarations defined in the scenario 450. With reference to the example scenario 200 depicted in FIGS. 2-3, the YAML text 206 indicates that a polled message is to be output every 300 seconds for the network simulation having a duration of 4000 seconds (see the YAML text 204). The YAML text 208 indicates that the output format for the polled messages are to be partially normalized. Accordingly, the scenario 450 can define the number and type of any polled messages to be output. If there are no polled messages to be output, operations continue at 1318 (further described below). If there are polled messages to be output, operations continue at 1312.

A configuration and template is retrieved for each of the message(s) to be output (1312). With reference to FIGS. 4-5, the data generator 402 transmits a request(s) to output the message(s) as defined in the scenario 450 to the message generator 405. The data generator 402 can transmit a separate request each time a message is to be output. For example, if the scenario indicated that two different polled messages that are partially normalized and three different polled messages that are non-normalized are to be output during the network simulation, the data generator 402 can transmit five different requests. The message generator 405 then forwards the request to the appropriate output formatter, depending on the type of output format. For example, if the polled message is to have a partially normalized format, the message generator 405 forwards the request to the partially normalized output formatter 404. If the polled message is to have a non-normalized format, the message generator 405 forwards the request to the non-normalized output formatter 407. If the polled message is to have a preprocessed format, the message generator 405 forwards the request to the preprocessed output formatter 411. In addition to the type of output format, the request from the message generator 405 includes a type of network element, and a context. The context can be metadata that the creation and output. For example, the context can include the network element type, a current time of when the message is generated, the data format (e.g., stored in files, memory, etc.), the output format (e.g., YAML, pre-processed, non-normalized, etc.), the technology types to simulate.

In response to receipt of the request, the output formatter (the partially normalized output formatter 404, the non-normalized output formatter 407, or the preprocessed output formatter 411) retrieves the appropriate configuration from the configuration store 116 and the appropriate template from the template store 118. As described above, each pair of configuration and template can be specific to a given technology type for a given type of network element. Therefore, the output formatter retrieves the configuration and template from the configuration store 116 and the template store 118, respectively, based on the type of network element and its technology type. As described above, the template defines what data is to be included in building the message, and the configuration defines how to populate the data in the message.

The message(s) are created based on the configuration and template (1314). With reference to FIGS. 4-5, the message generator 405 can retrieve data from the normalized inventory 112 for the associated network elements. For example, assume that the message is for the status of all virtual machines in the simulated network. The message generator 405 can retrieve the normalized attributes for each virtual machine in the simulated network from the normalized inventory 112. For instance, normalized attributes for a virtual machine can include its unique ID and its associated hypervisor.

If the message is a non-normalized message or a pre-processed message, the message includes attributes that are specific to a technology type. These attributes that are specific to a technology type are not stored in the normalized inventory 112. Rather, the message generator 405 can create and assign values to these attributes. In some embodiments, the message generator 405 can randomly assign these values for the different network elements whose attributes are included in the message. Additionally, if the message is a pre-processed message, the message generator 405 can include the metadata to the message. As described above, the metadata can include a timestamp for the response, the type of message, the status of the message, the source of the message, etc. The message generator 405 can generate the messages based on the template for the network element. For example, the messages can be generated based on the requested technologies and the network configuration. For instance, assume the network simulation is to output messages that are for the technology types—OpenStack and OpenDaylight. Also, assume that the message to be output is for the virtual machines in the network. In this example, there is a template for an OpenStack virtual machine but no template for an OpenDaylight virtual machine. Accordingly, a message for an OpenStack virtual machine is generated, but no message is generated for the OpenDaylight technology type. An example of a non-normalized message that is specific to a technology type is depicted in FIG. 7 (described above). An example of a pre-processed message is depicted in FIGS. 8-9 (described above). If the message is a partially normalized message, the message generator 405 normalizes the data for a network management system of a specific vendor or product. An example of a partially normalized message is depicted in FIG. 10 (described above).

The message(s) are output based on the timing defined in the scenario (1316). With reference to FIGS. 4-5, the message generator 405 outputs the message(s) based on the timing defined in the scenario 450. With reference to the example scenario 200 of FIGS. 2-3, the message generator 405 outputs a message at each polling interval, which is defined as every 300 seconds (see YAML text 206). The message generator 405 can output the message to various devices, communication buses (e.g., API bus), etc. As further described below in reference to FIG. 14, the message generator 405 can output the message to a plugin within a virtual network assurance manager. Alternatively, the message generator 405 can output the message directly to one or more of the network management systems.

Alternatively or in addition to outputting polled messages, the network simulator 104 can also output performance data for one or more network elements in the simulated network. The outputting of polled messages and outputting of performance data can overlap. Alternatively, outputting of polled messages and performance data be performed at the same time or performed at different non-overlapping times. Operations for outputting of performance data are depicted at 1318-1320 (which are now described).

A determination is also made of whether there are any performance data scheduled to be output (1318). With reference to FIGS. 4-5, the data generator 402 can make this determination based on the declarations defined in the scenario 450. With reference to the example scenario 200 depicted in FIGS. 2-3, the YAML text 214 indicates that performance data is scheduled to be output every 500 seconds for the network simulation having a duration of 4000 seconds (see the YAML text 204). The performance data to be output can include performance data for all network elements, a set of network elements, or an individual network element in the simulated network. For example, the performance data for all the virtual machines can the output. In another example, the performance data for all interfaces of a given technology type can be output. In some embodiments, the scenario 450 can define which performance data to output. If the specific network elements for which performance data is to be output is undefined in the scenario 450, the default can be the performance data of all network elements in the simulated network. If there is no performance data scheduled to be output, operations of the flowchart 1300 are complete. If there is performance data scheduled to be output, operations of the flowchart 1300 continue at 1320.

Performance data is output according to the scheduled interval as defined in the scenario (1320). With reference to FIGS. 4-5, the data generator 402 transmits a request(s) to output the performance data as defined in the scenario 450 to the message generator 405. The data generator 402 can transmit a separate request each time performance data is scheduled to be output. The request can include identification of which network elements for which performance data is to be output. The message generator 405 can then retrieve the performance data from the performance data store 403 for the network elements that have been identified. The message generator 405 outputs the performance data based on the timing defined in the scenario 450. With reference to the example scenario 200 of FIGS. 2-3, the message generator 405 outputs a message at each scheduled interval, which is defined as every 500 seconds (see YAML text 214). The message generator 405 can output the performance to various devices, communication buses (e.g., API bus), etc. As further described below in reference to FIG. 14, the message generator 405 can output the performance data to a plugin within a virtual network analyzer. Alternatively, the message generator 405 can output the message directly to one or more of the network management systems. Operations of the flowchart 1300 are complete as defined by the duration of the network simulation. With reference to the example scenario 200 of FIGS. 2-3, the YAML text 204 defines the duration of the network simulation to be 4000 seconds.

### Example Application—Virtual Network Assurance (VNA) Verification

An example application of the network simulation is now described. In particular, FIG. 14 depicts an example application of the network simulation to verify VNA operations, according to some embodiments. FIG. 14 depicts a system 1400 that includes a network simulator 104, a VNA manager 1403, a network management system 1451, a network management system 1453, a network management system 1455, and a comparator 1491. While depicted with three network management systems, the system 1400 can include a lesser or greater number of network management systems.

The network simulator 104 includes the normalized inventory 112, and a formatter 120. The normalized inventory 1404 includes instances of different types of network elements that are part of the simulated network. The VNA manager 1403 includes a technology A plugin 1430, a technology B plugin 1432, a technology N plugin 1434, and a normalized inventory 1437. While depicted with three plugins for specific technology types, the VNA manager 1403 can include a lesser or greater number of such plugins. As further described below, the network simulator 104 can periodically output polled messages at different interval of the simulation. The type of polled messages and the intervals of when the polled messages are output can be defined in a scenario that is an input to define the network simulation (as further described below). The polled messages can include data that provides the number of each type of network element (e.g., a virtual machine, a hypervisor, etc.) along with attributes, status, performance, etc. for each network element. Also, the polled messages can be formatted to be non-normalized and specific to technology types.

The formatter 120 outputs polled messages that are received by the VNA manager 1403. In this example, the polled messages include polled messages for virtual machines 1420, polled messages for hypervisors 1422, polled messages for tenants 1424, and polled messages for service function chain 1426. Although not shown, the formatter 120 can output polled messages for other types of network elements (e.g., controllers, tenants, interfaces, networks, etc.), as further described below.

In this example, the polled messages for virtual machines 1420 include polled messages for virtual machines based on technology A and polled messages for virtual machines based on technology B. The polled messages for the hypervisors 1422 include polled messages for hypervisors based on technology A and polled messages for hypervisors based on technology B. The polled messages for the tenants 1424 include polled messages for tenants based on technology A and polled messages for tenants based on technology B. The polled messages for the service function chains 1426 include polled messages for service function chains based on technology B and polled messages for service function chains based on technology N.

The technology A plugin 1430 receives polled messages that are formatted based technology A. The technology B plugin 1432 receives polled messages that are formatted based technology B. The technology N plugin 1434 receives polled messages that are formatted based technology N. The technology plugins then populate the normalized inventory 1437 with normalized representations of the network elements included in the polled messages. In particular, the technology A plugin 1430 creates a normalized representation of each the network elements that are based on technology A and identified by polled messages received from the network simulator 104. The technology A plugin 1430 then stores these normalized representations in the normalized inventory 1437. The technology B plugin 1432 creates a normalized representation of each the network elements that are based on technology B and identified by polled messages received from the network simulator 104. The technology B plugin 1432 then stores these normalized representations in the normalized inventory 1437. The technology N plugin 1434 creates a normalized representation of each the network elements that are based on technology N and identified by polled messages received from the network simulator 104. The technology N plugin 1434 then stores these normalized representations in the normalized inventory 1437.

Each of the network management systems 1451-1453 can be from different vendors and are used to monitor the network elements in the simulated network. Each of the network management systems 1451-1453 are configured to retrieve the normalized representation of the simulated network from the normalized inventory 1437.

Accordingly, if the technology plugins in the VNA manager 1403 are operating correctly, the simulated network with its various network elements connected together stored in the normalized inventory 112 should be the same as the simulated network with its various network elements connected together stored in the normalized inventory 1437. The comparator 1491 can retrieve the version of the simulated network from the normalized inventory 112 and the version of the simulated network from the normalized inventory 1437. The comparator 1491 can then compare the number of network elements and the connectivity among these network elements between the two versions of the simulated network to validate if the versions are the same. This validation by the comparator 1491 can be performed at different points of operation of the network simulator 104. For example, the validation can occur after any polling interval that causes output of polled messages to define the simulated network. In another example, the validation can occur after any change in the simulated network is identified by a polled message. For instance, if network elements are added or deleted and the polled messages identify these additions or deletions from the simulated network, the comparator 1491 can validate that the two versions of the simulated network are the same. In some embodiments, the comparator 1491 can perform validation any time an update is made to the normalized inventory 1437.

### Example Computer Device

FIG. 15 depicts an example computer device, according to some embodiments. The computer device includes a processor 1501 (possibly including multiple processors, multiple cores, multiple nodes, and/or implementing multi-threading, etc.). The computer device includes memory 1507. The memory 1507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media.

The computer device also includes a persistent data storage 1509. The persistent data storage 1509 can be a hard disk drive, such as magnetic storage device. The computer device also includes a bus 1503 (e.g., PCI, ISA, PCI-Express, HyperTransport® bus, InfiniBand® bus, NuBus, etc.) and a network interface 1505 (e.g., a Fiber Channel interface, an Ethernet interface, an internet small computer system interface, SONET interface, wireless interface, etc.).

The computer device also includes a network simulator 1511. The network simulator 1511 can perform network simulation operations, as described above. Any one of the previously described functionalities may be partially (or entirely) implemented in hardware and/or on the processor 1501. For example, the functionality may be implemented with an application specific integrated circuit, in logic implemented in the processor 1501, in a co-processor on a peripheral device or card, etc. Further, realizations may include fewer or additional components not illustrated in FIG. 15 (e.g., video cards, audio cards, additional network interfaces, peripheral devices, etc.). The processor 1501, the network interface 1505, and the persistent data storage 1509 are coupled to the bus 1503. Although illustrated as being coupled to the bus 1503, the memory 1507 may be coupled to the processor 1501.

### Variations

In some embodiments, the technology types to be simulated can also be randomly selected. For instance, assume that five different technology types can be used for network element A, four different technology types can be used for network element B, and eight different technology types can be used for network element C. The network simulator can randomly determine the technology type for each of the network elements A-C to be used for the network simulation.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing. Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

While the aspects of the disclosure are described with reference to various implementations and exploitations, it will be understood that these aspects are illustrative and that the scope of the claims is not limited to them. In general, techniques for performing metric contextualization in distributed computing environments as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
parsing a scenario to determine a set of declarations that define creation of a simulated network having a plurality of network elements, wherein the set of declarations define a type and a quantity for each of the plurality of network elements and defines at least one technology type for a plurality of mock inventory messages to be output from a network simulation of the simulated network;
creating normalized versions of the plurality of network elements based on the type and the quantity defined by the set of declarations, wherein creating the normalized versions comprises creating a first normalized version of a first network element that comprises,
determining whether the first network element is composed of other network elements; and
in response to determining that the first network element is composed of the other network elements,
creating each of the other network elements;
determining connectivity among the other network elements; and
mapping the other network elements together based on the connectivity;
storing the normalized versions of the plurality of network elements in a first normalized inventory; and
executing the network simulation of the simulated network, wherein executing the network simulation comprises,
outputting the plurality of mock inventory messages that include attributes and status of the plurality of network element from a perspective of the at least one technology type.

2. The method of claim 1, wherein outputting the plurality of mock inventory messages comprises outputting the plurality of mock inventory messages at a periodic interval defined by the set of declarations.

3. The method of claim 1, wherein outputting the plurality of mock inventory messages comprises outputting a first mock inventory message of the plurality of mock inventory messages that includes the quantity and the attributes of a first set of network elements of the plurality of network elements of a first network element type, wherein the first mock inventory message is from the perspective of a first technology type of the at least one technology type.

4. The method of claim 3, wherein outputting the plurality of mock inventory messages comprises outputting a second mock inventory message of the plurality of mock inventory messages that includes the quantity and the attributes of a second set of network elements of the plurality of network elements that are of a second network element type, wherein the second mock inventory message is from the perspective of a second technology type of the at least one technology type.

5. The method of claim 1, further comprising:
creating, based on the plurality of mock inventory messages that are output, a second normalized inventory that includes the plurality of network elements; and
comparing the first normalized inventory to the second normalized inventory.

6. The method of claim 5, further comprising:
validating the second normalized inventory in response to the first normalized inventory being equal to the second normalized inventory based on the comparing.

7. The method of claim 1, further comprising:
in response to determining that the first network element is composed of the other network elements, randomly selecting a quantity of each of the other network elements that are to be created.

8. The method of claim 1, wherein determining connectivity among the other network elements comprises randomly determining connectivity among the other network elements.

9. The method of claim 1, wherein creating the normalized versions of the plurality of network elements comprises creating a first normalized version of a first network element of the plurality of network elements, the first network element is of a first network element type, wherein the first normalized version includes only attributes that are common across technology types for the first network element type.

10. An apparatus comprising:
a processor; and
a machine-readable medium having program code executable by the processor to cause the apparatus to:
parse a scenario to determine a set of declarations that define creation of a simulated network having a plurality of network elements, wherein the set of declarations define a type and a quantity for each of the plurality of network elements and defines at least one technology type for a plurality of mock inventory messages to be output from a network simulation of the simulated network;
create normalized versions of the plurality of network elements based on the type and the quantity defined by the set of declarations, wherein the program code executable by the processor to cause the apparatus to create the normalized versions comprises program code executable by the processor to cause the apparatus to create a first normalized version of a first network element, wherein the program code executable by the processor to cause the apparatus to create the first normalized version comprises program code executable by the processor to cause the apparatus to,
determine whether the first network element is composed of other network elements; and
in response to a determination that the first network element is composed of the other network elements,
create each of the other network elements;
determine connectivity among the other network elements; and
map the other network elements together based on the connectivity;
store the normalized versions of the plurality of network elements in a first normalized inventory; and
execute the network simulation of the simulated network, wherein the program code executable by the processor to cause the apparatus to execute the network simulation comprises program code executable by the processor to cause the apparatus to,
output the plurality of mock inventory messages that include attributes and status of the plurality of network element from a perspective of the at least one technology type.

11. The apparatus of claim 10, wherein the program code executable by the processor to cause the apparatus to output the plurality of mock inventory messages comprises program code executable by the processor to cause the apparatus to output the plurality of mock inventory messages at a periodic interval defined by the set of declarations.

12. The apparatus of claim 10, wherein the program code executable by the processor to cause the apparatus to output the plurality of mock inventory messages comprises program code executable by the processor to cause the apparatus to output a first mock inventory message of the plurality of mock inventory messages that includes the quantity and the attributes of a first set of network elements of the plurality of network elements of a first network element type, wherein the first mock inventory message is from the perspective of a first technology type of the at least one technology type.

13. The apparatus of claim 12, wherein the program code executable by the processor to cause the apparatus to output the plurality of mock inventory messages comprises program code executable by the processor to cause the apparatus to output a second mock inventory message of the plurality of mock inventory messages that includes the quantity and the attributes of a second set of network elements of the plurality of network elements that are of a second network element type, wherein the second mock inventory message is from the perspective of a second technology type of the at least one technology type.

14. The apparatus of claim 10, wherein the program code comprises program code executable by the processor to cause the apparatus to:
create, based on the plurality of mock inventory messages that are output, a second normalized inventory that includes the plurality of network elements; and
compare the first normalized inventory to the second normalized inventory.

15. The apparatus of claim 14, wherein the program code comprises program code executable by the processor to cause the apparatus to:
validate the second normalized inventory in response to the first normalized inventory being equal to the second normalized inventory based on the compare.

16. The apparatus of claim 10, wherein the program code comprises program code executable by the processor to cause the apparatus to:
in response to a determination that the first network element is composed of the other network elements, randomly select a quantity of each of the other network elements that are to be created.

17. The apparatus of claim 10, wherein the program code executable by the processor to cause the apparatus to determine connectivity among the other network elements comprises program code executable by the processor to cause the apparatus to randomly determine connectivity among the other network elements.

18. The apparatus of claim 10, wherein the program code executable by the processor to cause the apparatus to create the normalized versions of the plurality of network elements comprises program code executable by the processor to cause the apparatus to create a first normalized version of a first network element of the plurality of network elements, the first network element is of a first network element type, wherein the first normalized version includes only attributes that are common across technology types for the first network element type.

19. One or more non-transitory machine-readable media comprising program code for a network simulation, the program code to:
parse a scenario to determine a set of declarations that define creation of a simulated network having a plurality of network elements, wherein the set of declarations define a type and a quantity for each of the plurality of network elements and defines at least one technology type for a plurality of mock inventory messages to be output from a network simulation of the simulated network;
create normalized versions of the plurality of network elements based on the type and the quantity defined by the set of declarations, wherein the program code to create the normalized versions comprises program code to create a first normalized version of a first network element, wherein the program code to create the first normalized version comprises program code to,
determine whether the first network element is composed of other network elements; and
in response to a determination that the first network element is composed of the other network elements,
create each of the other network elements;
determine connectivity among the other network elements; and
map the other network elements together based on the connectivity;
store the normalized versions of the plurality of network elements in a first normalized inventory;
execute the network simulation of the simulated network, wherein the program code to execute the network simulation comprises program code to,
output the plurality of mock inventory messages that include attributes and status of the plurality of network element from a perspective of the at least one technology type;
create, based on the plurality of mock inventory messages that are output, a second normalized inventory that includes the plurality of network elements;
compare the first normalized inventory to the second normalized inventory; and
validate the second normalized inventory in response to the first normalized inventory being equal to the second normalized inventory based on the compare.

20. The one or more non-transitory machine-readable media of claim 19, wherein the program code to output the plurality of mock inventory messages comprises program code to output the plurality of mock inventory messages at a periodic interval defined by the set of declarations.
